(19) United States
(12) Patent Application Publication
(10) Pub. No.: US 2024/0112101 A1
(43) Pub. Date: Apr. 4, 2024

(54) DYNAMIC ADVISOR ACCESS AND SCHEDULING

(71) Applicant: FORD GLOBAL TECHNOLOGIES, LLC, Dearborn, MI (US)

(72) Inventors: Stuart C. Salter, White Lake, MI (US); Meghan Preiss, Detroit, MI (US); Pietro Buttolo, Dearborn Heights, MI (US); Brendan F. Diamond, Grosse Pointe, MI (US); Ryan O'Gorman, Beverly Hills, MI (US)

(21) Appl. No.: 17/958,776

(22) Filed: Oct. 3, 2022

(51) Int. Cl. G06Q 10/06

(52) U.S. Cl. CPC G06Q 10/063112

(57) ABSTRACT

A system receives a request for assistance on a task, the request at least identifying the task. The system determines one or more designated entities having predefined characteristics associated therewith indicating suitability for assistance and determines a current status of each determined entity and whether the status indicates availability for assistance. Further, the system contacts at least one of the entities for which the characteristics indicate suitability and for which the status indicates availability and, responsive to at least one entity indicating willingness to assist, opens a communication channel between a requestor, from whom the request originated, and the at least one entity indicating willingness to assist.

### TECHNICAL FIELD

The illustrative embodiments generally relate to methods and apparatuses for dynamic advisor access and scheduling.

### BACKGROUND

Large companies have thousands of specialized employees they can deploy to given jobs as needed. Often, certain specialists will travel from job to job, providing technical expertise as needed. Even within the trades, journeymen will often need to consult a master, but masters tend to be in shorter supply than journeymen. Thus, a master, when a company is short on masters, may find themselves traveling from site to site to provide a day's worth of instruction for the journeymen deployed to the site, before moving to another site to repeat the task.

Problematically, if an issue arises for which the master would need to be consulted, and the master has already left for another site, the journeymen onsite may find themselves unable to proceed until the master can be reached or returns to the site.

In a similar vein a first trade, such as a builder, may want to consult a second trade, such as an electrician, about the implications of cutting a bundle of wires. Since the site may not be ready for the electrical trades, the electricians may not yet be onsite, and the builders, wanting to complete the task to which they are assigned, may simply cut the wires to proceed, figuring that the electricians can later repair any lingering issues this may cause.

When the trade is an independent contractor, as opposed to a part of a larger organization staffing many trades, they may not even know the electrician (or whichever trade) assigned to the task about which they seek to consult. Thus, they may not even have the option to simply call the tradesman and ask the question, assuming the tradesman would even answer the phone. General contractors can sometimes serve in an assistance role in this scenario, but they cannot afford to spend their entire day functioning as switchboard operators, routing calls from one trade to another. Further, there are never any assurances that a given tradesman, who is likely busy with their own tasks, will even answer the phone. Accordingly, a tradesman may have to call a dozen known other tradesman to obtain answers, and this can result in significant downtime.

### SUMMARY

In a first illustrative embodiment, a system includes one or more processors configured to receive a request for assistance on a task, the request at least identifying the task. The one or more processors are also configured to determine one or more designated entities having predefined characteristics associated therewith indicating suitability for assistance and determine a current status of each determined entity and whether the status indicates availability for assistance. Further, the one or more processors are configured to contact at least one of the entities for which the characteristics indicate suitability and for which the status indicates availability and, responsive to at least one entity indicating willingness to assist, open a communication channel between a requestor, from whom the request originated, and the at least one entity indicating willingness to assist.

In a second illustrative embodiment, a method includes receiving a request for assistance on a task, the request at least identifying the task and determining one or more designated entities having predefined characteristics associated therewith indicating suitability for assistance stored in an entity data store. The method also includes determining a current status of each determined entity based on status reported from each entity and whether the status indicates availability for assistance. Further, the method includes contacting at least one of the entities for which the characteristics indicate suitability and for which the status indicates availability and, responsive to at least one entity indicating willingness to assist, opening a communication channel between a requestor, from whom the request originated, and the at least one entity indicating willingness to assist.

In a third illustrative embodiment, a method includes receiving a request for assistance on a task, the request at least identifying the task. The method also includes determining one or more designated entities having predefined characteristics associated therewith indicating suitability for assistance stored in an entity data store that also have current statuses associated therewith, as indicated by respective designated entities, that indicate that a given respective entity is currently in transit. Further, the method includes contacting at least one of the plurality of entities for which the characteristics indicate suitability and for which the status indicates in transit and receiving a response from at least one contacted entity. Additionally, the method includes, responsive to the response indicating willingness to assist, determining whether a type of response is suitable for immediate assistance based at least on whether the response requires video communication and, responsive to determining that the response does not require video communication, opening a communication channel between a requestor, from whom the request originated, and the at least one contacted entity indicating willingness to assist.

### BRIEF DESCRIPTION OF THE DRAWINGS

FIG. 1 shows an illustrative example of an advisor monitoring and access system;

FIG. 2 shows an illustrative example of a task analysis process;

FIG. 3 shows an illustrative example of an advisor communication process; and

FIG. 4 shows an illustrative example of an advisor selection process.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Communication between systems and processes may include use of, for example, Bluetooth, Wi-Fi, cellular communication and other suitable wireless and wired communication.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

The illustrative embodiments propose a solution where skilled labor, or labor having a particular skill set, can advertise an “available” presence while traveling in a vehicle. Since the tradesman is unlikely engaged in work while traveling, this presents an opportunity for consultation as the tradesman moves to a next job. Trades tend to spend significant amounts of time in vehicles, and that is effectively downtime for those trades, meaning their specialized services are going unused as they are driving. Even if the consultation requires a brief stop, because a graphic or other view needs to be analyzed, the traveling tradesman may be incentivized to stop because this can be a revenue generating opportunity, or an opportunity to repay or gain a favor.

Within a large organization, where the trades are somewhat obligated to do as the company dictates, it still may be difficult to track available trades across many jobs. Accordingly, if Site A needs a master consult, and the master is enroute to Site B, but there is no general dispatcher who knows all of this information, the job at Site A may be delayed until the master can be reached. If the vehicle in which the master travels could broadcast the fact that the master is traveling, the company could decide the best use of the master's time, which could include prioritizing the consultation by asking the master to stop while enroute and answer the question. Since the vehicle is capable of displaying messages in many instances, this process does not necessarily require a phone call to begin, and the vehicle operator or passenger can simply be notified of the need and the priority of the task without having to access their mobile device.

Further, vehicles can analyze surroundings as they travel and determine which candidate vehicles are suitable for consultation. For example, a master traveling in a vehicle at 70 mph in heavy traffic may be considered less available than a master driving 25 mph down an empty dirt road. If both can assist, a coordination process can prioritize requests to the more available vehicle/master.

It is worth noting that while the concepts are described in the context of trade consulting, the concepts extend to any formal or loosely structured organization including entities having specialized skills. For example, salespeople may be constantly traveling and meeting with customers, and a production manager may need a consultation from a salesperson about what should be included in an order. The salespeople that are available could broadcast availability while traveling, and the consultation could be much easier to perform, preventing unnecessary production delays.

Within a group of independent entities lacking formal affiliation with each other, similar concepts allow for on-demand consulting of those with the relevant skills. For example, a private builder could be part of a network of trade consultants, and could be told when at least one master electrician (or plumber, mason, etc.) was available for consultation. This saves the builder time and the customer money, and ensures the job gets done correctly and efficiently. Even if there is a fee associated with the consultation, the customer will likely happily pay this fee relative to the expense of later repairing something the builder did incorrectly in the interest of moving the job along on schedule.

By contemplating variables such as skill sets, availability, complexity of request and driving scenarios, among other things, the illustrative embodiments can produce fast consultations with available skilled entities that are likely to and capable of responding to a request. Vehicle displays, sound systems and cameras can be leveraged to provide an immersive and comprehensive response when needed. For example, a journeyman could show a live feed from a phone played back through a vehicle display. A responding master could park, perform a quick demonstration in front of a vehicle camera, and then travel along their way. This alternative to waiting for the master to be onsite can literally save days' worth of delays per job.

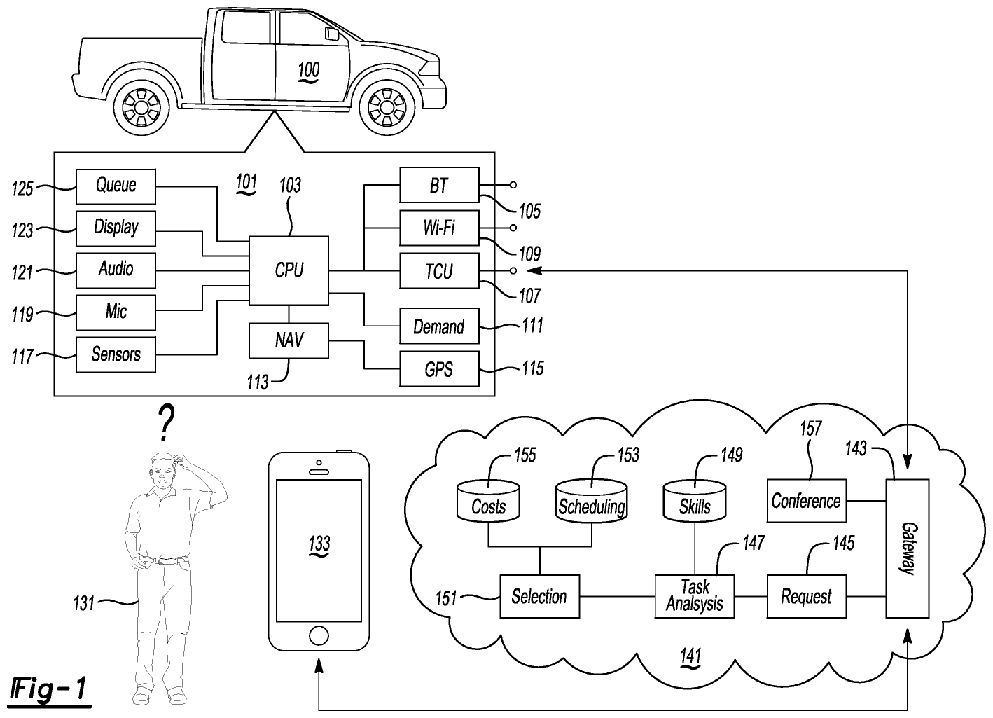

FIG. 1 shows an illustrative example of an advisor monitoring and access system. In this example, traveling vehicles 100 that include a person with specialty skills can notify a general system when those persons are available. The vehicle 100 includes a computing system 101 with one or more processors 103 and a variety of communication mediums. In this example, that includes BLUETOOTH transceiver 105, a telematics control unit 107 and a Wi-Fi transceiver 109. The BLUETOOTH and Wi-Fi transceivers can be used for short range direct communication, and the TCU and Wi-Fi transceiver can be used for longer range communication, with the Wi-Fi transceiver acting in this capacity when a wide area network access point is available.

An onboard demand process 111 can determine driver availability and/or passenger availability based on environmental conditions surrounding a vehicle 100 in transit and vehicle states. This can include, for example, speed, weather, traffic, routes, etc. A route can also be used in conjunction with vehicle or driver states to determine if a stop is needed or possible—the driver may commonly stop for food around certain times and/or may need fuel or energy. These stopping points may represent logical instances of low or no demand, and the specialist can assist remote parties while engaging in an otherwise necessary or desired stop.

A navigation process 113 working in conjunction with a GPS 115 can determine likely stopping points based on any predicted or indicated driver needs. The vehicle 100 may also use BLUETOOTH, Wi-Fi or a direct connection to a mobile device for navigation and routing, and may not have native onboard navigation. The driver demand process can still use the shared information from the mobile device to determine a route and any areas of predicted low demand, if the driver demand is presently too high at any given moment when a request for assistance is detected.

The vehicle 100 may also include onboard sensors 117, such as LIDAR, RADAR, cameras, etc., to assess driving demand, traffic conditions, etc. This can also aid in the demand determination. The demand determination may be relative to a given request—e.g., a request for a short verbal answer may require less driver focus than a request for a live video feed Q&A session where the specialist may need to view photos or video of a situation and respond verbally or with a video response.

For situations where the vehicle is used as a communication medium with a remote requestor, the vehicle 100 can leverage microphones 119, audio systems 121 and displays 123. The vehicle may also include exterior cameras, which can be useful if the respondent needs to show a remote requestor how to do something (e.g., assemble a pipe fitting, wire an object, etc.). Using an interior camera for such a task may be possible, but the logistics of demonstrating a process in a tight vehicle cabin may make the exterior camera preferable, depending on what is needed. A mobile device can provide a screen for the specialist, so the specialist can confirm that the video being recorded and relayed by the vehicle shows what the remote requestor needs to see.

For example, a master plumber may need to demonstrate assembly of a complicate pipe fitting solution, and may want to do so while standing outside of a truck. This would obviously require a stopping point, and perhaps one at a location where it is likely easy for the specialist to access the truck bed, obtain and assemble the necessary parts—such as a larger parking lot. The demand and/or any other analysis processes can take the response type into accommodation. This may also require feedback from the specialist—e.g., a requestor can submit a request without being certain of the response type, a responding specialist can quickly indicate that this will require a video response, and then the demand process 111 can look for stopping points that will facilitate the response.

The vehicle 100 may also include a queuing process 125, which can queue requests for a time when the specialist is more available. If no specialist can be found that is immediately available, multiple vehicles 100 may queue the request, and whichever one is first available can fulfil the request, while notifying the other vehicles that the request has been serviced.

The remote requestor 131 can use a mobile device 133 to submit the requests as needed. The remote requestor 131 may also submit request through other vehicle computing systems as desired, depending on what mediums are available at the site for request submission.

A backend in the cloud 141 can facilitate response handling and driver determinations. A gateway 143 process can route specialist requests to the appropriate vehicles and specialists in the field. A request handling process 145 can receive incoming requests and use an analysis process 147 to determine which specialist types are needed (if not indicated in the request) and what sort of response may be required. Predefined parameters for certain common requests can be used to determine if the request response is a verbal or visual response. A database of skills 149 can indicate which parties within an organized structure are capable of request handling.

It is worth noting that the organized structure need not be a formal organization, and can also include a service whereby skilled parties from any walk of life indicate their capabilities and availabilities. This allows for smaller independent operators to function in conjunction as a larger entity for assistance, and can provide both supplemental income and fast responses for entities that may otherwise lack the resources to obtain quick results. Ratings systems and comparable analysis can preferentially order the skilled entities to help ensure accurate results are being provided.

Once one or more skilled parties have been identified, the selection process 151 can provide feedback to the requestor for specialist selection, if more than one specialist is available. This can include, in some instances, fee information 155 if the specialist is a for-fee service, and scheduling 153 if the specialist is not immediately available. Fees and scheduling information can also be used in specialist selection, and can be used as search constraints as well, to prevent overcharges for responses and/or to prevent obtaining a specialist who has other obligations prior to the completion of a response time, which can be both estimated by the analysis process 147 and/or confirmed by the specialist.

In larger organizations, the fee may be a non-factor or can be used to determine the “price” to the organization in terms of the hourly fee or salary of the specialist, and this can be used to rank competing tasks that otherwise have equal priority. For example, a task that would require overtime pay for the organization can be compared to allowing the specialist to simply finish their planned day and respond to the task the next day, and the delay at a late time of day may be negligible—responding to a problem at 4:45 PM one day vs. 8:00 AM the next day may not result in significant site delay, and the specialist fee for overtime response may not justify the usage of the specialist until the next day. Again, while the examples are presented from the context of construction trades and specialists, the concepts extend to any area where on-demand responses from a party with a specialized skill may be useful.

The cloud 141 may also provide conferencing services 157, which allow for video chats and other services. This can also include, for example, a digital library of parts and/or digital tools that allow for replication of assemblies or processes, so that a specialist can provide a virtual demonstration of how to handle a task if the physical recreation is too difficult given circumstances. This can further include access to a variety of technical manuals, so a specialist can walk through a process with a remote requestor.

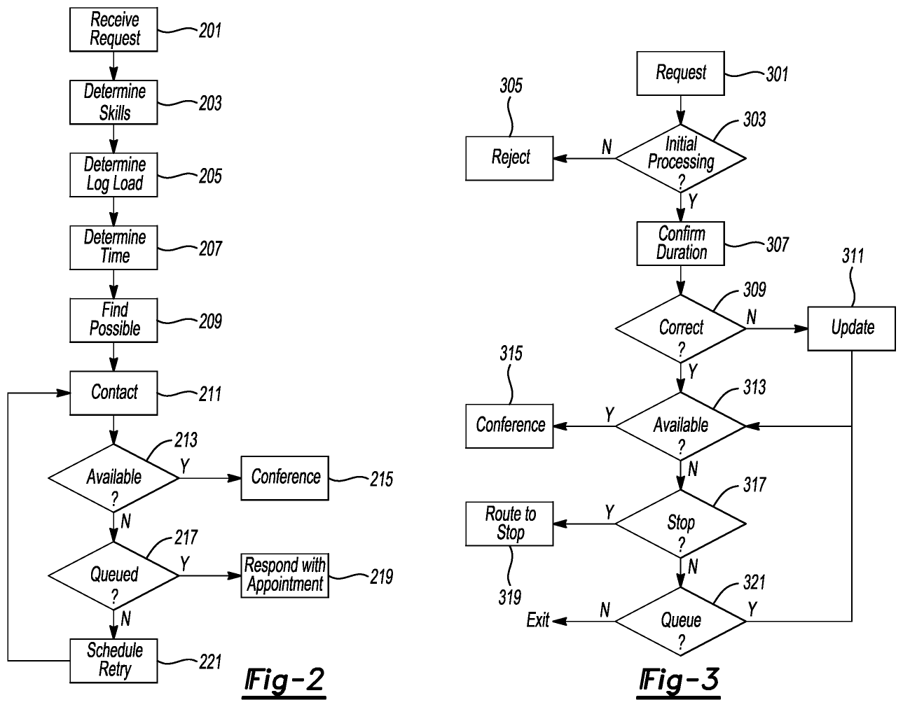

FIG. 2 shows an illustrative example of a task analysis process. This is an example of a process that can be used to determine the types of skills needed for an answer, time requirements, cognitive load requirements, video vs. audio, etc. It is also possible the requestor can indicate some or all of this information as part of the request, and the process can confirm the requested parameters. As discussed later with respect to FIG. 3, one or more possible technical advisors can also confirm or alter parameters if they believe the stated requirements to be off base.

In this example, a request is received at 201 by the analysis process, from a remote requestor using a mobile device, vehicle computing system, etc. to submit the request. The process then determines necessary skills to respond at 203, which can be based on inclusion of skills in the request, or analysis of a process or question covered by the request. For example, a requestor may ask “what is the wiring configuration intended for X aspect of a project,” and may indicate that the master electrician responsible for the project is the suitable respondent. In another instance, the requestor may ask “which three of the four available wires in this image should be used to connect a 3-wire fixture,” and the process may determine that any skilled electrician should be able to answer the question.

The cognitive load required for answering can also be determined at 205. This may be based on, for example, whether the request includes an image or complicated (e.g., long) question, has multiple parts for response, whether the response requires a video and/or whether a video response was requested, etc. If the request is short, e.g., “is the red or white wire the third wire to use in a 3-wire fixture with a 4-wire junction,” then the cognitive load may be low. If the request is complicated, e.g. “please view this video of the panel and homeruns and indicate the wiring plan for eleven distinct circuit paths,” the cognitive load may be very high. It may be the case that when an image or video is to be viewed, the cognitive load requirements may be such that only when the respondent is a passenger, stopped and parked, in an autonomous vehicle, etc., can the respondent be considered “available.”

The process may also determine the time required to respond at 207. This may be a rough estimate based on both the complexity of the question and the level of skill of a given respondent, as well as other factors such as included imagery that needs to be viewed and analyzed, length of any included video, etc. The requestor can also indicate that, for example, the request will include a live video walkthrough of at least X minutes. The duration of the response may matter because if the respondent is on the way to another job, they will require sufficient time to answer the question, which may affect their availability. If a stop is planned to permit answering, the answer may need to encompass an amount of time not more than a threshold over projected stopping time—e.g., if the response is projected to take 30 minutes, that will run well past a typical gas-refill stop duration. This may also help in prioritizing requests for inhouse personnel, by determining the required delay and any effect that may have on the original task to which the respondent was headed.

If there is at least one available person to answer the request at 209, or at least one person qualified to answer the request, the process can contact that vehicle 100 at 211. The request may not be (or may be) delivered directly to the occupant initially. When the request is not delivered directly, the vehicle 100 may opine about the current cognitive load and availability of the proposed respondent. When the request is delivered directly, it may be in a redacted format, such as, but not limited to—“do you have X minutes to respond to a question relating to Y, projected to require viewing of a series of images and preferably including video chat?” Or it could be even more redacted, such as “do you have X minutes to respond to a request requiring a stop?”

If the vehicle or proposed respondent indicates availability at 213, the process can open a conference call at 215. This may not necessarily include video, and some questions can be answered by a simple audio response. Certain questions may even be answered by a recorded response, such as the respondent saying “use the red wire” and then the requestor can ask for further information if that response is insufficient, but where no active live connection may need to be established.

If there is no proposed respondent available at 213, the process can attempt to queue the question for response at 217. If the process is queued at one or more vehicles at 217, the process can communicate a likely availability to the requestor at 219, or make an appointment for response. Otherwise, the process (which in this example is acting in the cloud) can schedule a retry for some later time period when different personnel may be in an available state. For example, if no personnel specialists are traveling with any capacity for response in their day, there is not necessarily a reason to queue the requests in those vehicles. But 30 minutes later, a new respondent may be traveling, who was previously not traveling, and thus may be available for responding to the question.

FIG. 3 shows an illustrative example of an advisor communication process. In this example, the vehicle 100 receives a request at 301. If the cognitive load or other factors (such as a tight schedule) indicate complete unavailability at 303, the vehicle 100 may reject the request off hand at 305. This can also occur when the request is lower priority (within an organization) than any pending tasks underway by traveling specialists, or when the fee structure proposed by the requestor does not meet any traveling respondents' minimum preferences/charges for response.

If there is at least a chance that the in-vehicle person can handle the response at 303, then the process can ask the respondent to confirm the proposed duration of the request at 307. This may also be a request that can be fulfilled by other unavailable personnel, who may have sufficient cognitive load to at least confirm that the request will take X minutes to complete, which can aid in finding an available respondent. For example, the request could go to a low-availability respondent with a low present cognitive load as “can you confirm that a request to do X will take approximately 30 minutes?” If the respondent says no at 309, they may verbally provide a new estimate. One or more such responses can be used to update a projected response duration at 311.

If the vehicle occupant is immediately available at 313, the vehicle may open a conference call at 315, or record a response, as is necessary for responding to a given request based on parameters of the request. If the respondent would be available if stopped, the vehicle may route the vehicle to an appropriate stopping point. For example, a schedule for a potential respondent may indicate 45 minutes of availability, but a current cognitive load may be too high, so the vehicle can route to a refueling point, restaurant, parking lot, etc. at 319 to change the cognitive load state and, at least in some instances, also fulfil a possible need of the respondent (fuel, food, etc.) in the process. Alternatively, if there may be availability later along a present route, which can be roughly predicted based on travel time, traffic, weather, etc., the vehicle may queue the request at 321.

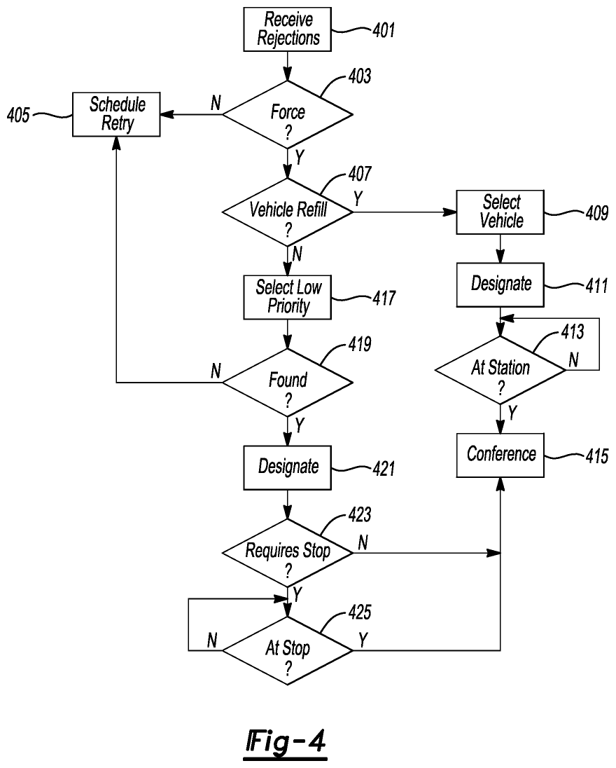

FIG. 4 shows an illustrative example of an advisor selection process for an intra organizational process that can provide overrides of daily instructions and tasks. That is, a system that can dictate whether a request should be answered immediately based on the needs of an organization. A comparable process could be used amongst a group of independents, although the parameters for forcing a response may be more along the lines of an individual respondent declaring themselves always available for a certain fee—so that when the request is “forcing” a response it is really notifying the respondent that the prioritization fee, as opposed to organizational prioritization, has been met. In a similar vein, respondents can designate certain requestors to whom they owe favors or, for example, in whom they have a vested interest, as those from whom they will accept a “forced” request.

If the request is fully rejected by vehicles and/or respondents at 401, the process may determine if any conditions for “forcing” a request are met at 403. This can include, for example, organizational priority associated with a request, fee parameters, etc. If there is no justifiable reason or party upon whom the response can be forced (potentially based on qualifications set by respondents and not necessarily literally having a right to force someone to respond, such as an employee hired for such a purpose), the process can schedule a time for retrying the request at 405, as discussed above.

If there are one or more parties who qualify for forcing of a request—e.g., by essentially overriding a vehicle-based rejection of a request to force the request through to delivery to the respondent, the process may determine if any efficiency, such as refueling in this example, can be achieved at 407. If the efficiency parameters are met at 407, which can also include lunch or snack breaks, breaks from long and/or arduous driving, etc., the process can select a candidate vehicle at 409 and designate that vehicle as a respondent vehicle at 411. Unless the operator expressly refuses to handle the request, the process may consider the request fulfilled and cease polling other vehicles 100 for possible response.

Once the vehicle reaches the destination (in this case a refueling station) at 413, the process can open a conference call at 415 and/or provide any necessary communication connections to fulfil the request. If at any point the respondent deviates from a route, indicates that they will not be able or are unwilling to respond, etc., the process can resume looking for other candidates.

If there are no available vehicles for an efficiency stop at 407, the process can attempt to determine which vehicle or vehicles have a low priority task associated therewith. Within an organization, tasks may have intra-organizational priority, and the process can first try for an efficiency stop (which may be a stop that would otherwise occur anyhow) and then try to replace a low priority task with the request, or the process may perform these steps in another order, as desired.

In this example, if there are no tasks with sufficiently low priority currently underway at 419 (i.e., all underway tasks have higher priority than a priority associated with the request), the process may schedule a retry. If a specialist assigned to a lower priority task is found at 419, the process may designate that specialist as being the one to respond to the inquiry at 421.

In the event a response requires a stop at 423, the process will wait until a stop is achieved in a suitable location, and/or route the vehicle to an appropriate location at 425. In at least one example, this can include routing to a location (e.g., a restaurant) with a known public Wi-Fi access point, if video chat is needed, to lower the overhead on communication between parties. A conference call can then be opened through the vehicle and cloud at 415 as needed.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, embodiments described as less desirable than other embodiments or prior art implementations with respect to one or more characteristics are not outside the scope of the disclosure and can be desirable for particular applications.

What is claimed is:

1. A system comprising:
one or more processors configured to:
receive a request for assistance on a task, the request at least identifying the task;
determine one or more designated entities having predefined characteristics associated therewith indicating suitability for assistance;
determine a current status of each determined entity and whether the status indicates availability for assistance;
contact at least one of the entities for which the characteristics indicate suitability and for which the status indicates availability; and
responsive to at least one entity indicating willingness to assist, open a communication channel between a requestor, from whom the request originated, and the at least one entity indicating willingness to assist.

2. The system of claim 1, wherein the characteristics associated with each entity are stored in an entity database.

3. The system of claim 2, wherein the characteristics include skill sets and wherein the suitability for assistance is determined based on a correlation between a skill set associated with a given entity and a preferred skill set determined with respect to the task.

4. The system of claim 3, wherein the task further includes indication of at least one preferred skill set.

5. The system of claim 1, wherein the current status of each determined entity is based on indicia received from each entity indicating whether the entity is available for assistance.

6. The system of claim 1, wherein the current status of each determined entity is based on at least in part on location data received from each entity and a determination that a given entity is available for assistance is based at least in part on the location data indicating that the given entity is in transit in a vehicle.

7. The system of claim 1, wherein the current status of each determined entity is based on at least in part on designated responsibility associated with each entity and a determination that a given entity is available for assistance is based at least in part on the designated responsibility indicating that the entity can be used for assistance.

8. The system of claim 1, wherein the one or more processors are further configured to:
determine, based on the request, that requested assistance requires video communication between the requestor and an assisting entity; and
responsive to at least one entity indicating willingness to assist and the at least one entity being in transit, recommend a stopping location for the at least one entity, wherein the opening a communication channel between a requestor, from whom the request originated, and the at least one entity is delayed until the recommended stopping location is reached.

9. The system of claim 8, wherein the determination that the requested assistance requires video communication is based on a type of response included in the request.

10. The system of claim 8, wherein the determination that the requested assistance requires video communication is based on an indication received from the at least one entity.

11. The system of claim 8, wherein the recommended stopping location relates to a determined need associated with the at least one entity based on information known about the at least one entity.

12. The system of claim 11, wherein the information known includes when the entity historically eats food and wherein the recommended stopping location includes a location providing food responsive to a current time falling within when the entity eats food.

13. The system of claim 11, wherein the information known includes a fuel status of a vehicle providing transit when the at least one entity is in transit and wherein the recommended stopping location includes a location providing refueling responsive to the fuel status being below a predefined threshold.

14. A method comprising:
receiving a request for assistance on a task, the request at least identifying the task;
determining one or more designated entities having predefined characteristics associated therewith indicating suitability for assistance stored in an entity data store;
determining a current status of each determined entity based on status reported from each entity and whether the status indicates availability for assistance;
contacting at least one of the entities for which the characteristics indicate suitability and for which the status indicates availability; and
responsive to at least one entity indicating willingness to assist, opening a communication channel between a requestor, from whom the request originated, and the at least one entity indicating willingness to assist.

15. The method of claim 14, wherein the characteristics include skill sets and wherein the suitability for assistance is determined based on a correlation between a skill set associated with a given entity and a preferred skill set determined with respect to the task.

16. The method of claim 15, wherein the task further includes indication of at least one preferred skill set.

17. The method of claim 14, further comprising:
determining, based on the request, that requested assistance requires video communication between the requestor and an assisting entity; and
responsive to at least one entity indicating willingness to assist and the at least one entity being in transit, recommending a stopping location for the at least one entity, wherein the opening a communication channel between a requestor, from whom the request originated, and the at least one entity is delayed until the recommended stopping location is reached.

18. The method of claim 17, wherein the determination that the requested assistance requires video communication is based on a type of response included in the request or on an indication received from the at least one entity.

19. A method comprising:
receiving a request for assistance on a task, the request at least identifying the task;
determining one or more designated entities having predefined characteristics associated therewith indicating suitability for assistance stored in an entity data store that also have current statuses associated therewith, as indicated by respective designated entities, that indicate that a given respective entity is currently in transit;
contacting at least one of the plurality of entities for which the characteristics indicate suitability and for which the status indicates in transit; and
receiving a response from at least one contacted entity;
responsive to the response indicating willingness to assist, determining whether a type of response is suitable for immediate assistance based at least on whether the response requires video communication;
responsive to determining that the response does not require video communication, opening a communication channel between a requestor, from whom the request originated, and the at least one contacted entity indicating willingness to assist.

20. The method of claim 20, further comprising notifying other of the one or more designated entities that assistance is no longer needed, responsive to opening the communication channel.
